(19) United States
(12) Patent Application Publication
(10) Pub. No.: US 2011/0143118 A1
(43) Pub. Date: Jun. 16, 2011

(54) FABRIC OBTAINED BY WORKING YARN RESULTING FROM THE TWISTING OF ANIMAL FIBRES TWISTED WITH A STRAND OF SILK

(75) Inventor: Pier Luigi Loro Piana, Borgosesia (IT)

(73) Assignee: Loro Piana S.p.A, Quarona (IT)

(21) Appl. No.: 12/994,702

(22) PCT Filed: Oct. 21, 2008
(86) PCT No.: PCT/EP2008/008884

§ 371 Date: Feb. 10, 2011

(30) Foreign Application Priority Data
May 29, 2008 (IT) T02008A000412

(51) Int. Cl. B32B 5/02

(52) U.S. Cl. 428/221

(57) ABSTRACT

A fabric obtained by working yarn results from twisting of natural fibres in which the natural fibres are animal fibres twisted with a strand of silk.

The subject of the invention is a fabric totally constituted by natural fibres with extremely light weights, which present, however, high characteristics of resistance and duration.

In particular, the fabric according to the invention is obtained by working yarn resulting from the twisting of animal fibres twisted with a strand of silk.

The market requires with ever increasing frequency extremely light fabrics for summer wear, transpirant and comfortable, but with features of resistance and durability.

For the production of extremely light-weight fabrics, extremely fine yarn must be used and hence yarn having a very high count.

Weaving of individual threads with a high count is, however, impossible in so far as the necessary consistency is missing. The threads of wool or other fibres twisted in pairs prove to be too thick and hence unsuitable for the production of such light fabrics.

For these reasons, to obtain fabrics made of very light animal fibres normally threads twisted with yarns made of synthetic fibres (e.g., nylon) are used, which bestow consistency and resistance upon the yarn, without thickening the yarn and consequently increasing the weight of the fabric deriving therefrom.

The use of synthetic fibres, even in a small percentage, however, has a negative effect on the characteristics of transpirablity, thermoregulation and hygroscopicity, which are peculiar qualities of natural fibres, for example of wool and cashmere.

Also last-generation artificial and synthetic fibres withhold the heat of the body and are not very absorbent: this renders them far from indicated for making fabrics for clothing for summer wear.

There is thus proposed an original use of silk, a natural animal fibre, which has a good hygroscopicity and high insulating capacity, in addition to excellent mechanical properties (high elasticity and resistance to tensile stress).

In this way, yarns are obtained that can undergo a process of weaving and finishing, giving rise to a new series of fabrics, which, otherwise, using either the yarn of silk by itself or the yarn consisting of animal fibre alone, could not be obtained.

For these and further purposes that will be appreciated more fully hereinafter, the invention proposes the production of a fabric obtained by working yarns resulting from the twisting of natural fibres, characterized in that the natural fibres are animal fibres twisted with a strand of silk.

An extremely fine strand of silk is then twisted with yarn made of natural fibres (for example, cashmere, wool, mohair, vicuña, etc.) of various counts to obtain an extremely fine and at the same time resistant yarn, and hence a yarn suitable for being woven. The fabrics produced with these yarns reach extremely light weights, are transpirant and comfortable and resistant over time.

The percentage compositions and counts of the yarns can vary to obtain fabrics with different features and effects of an aesthetic nature and of feel.

Some examples of wool/silk and cashmere/silk yarns are listed in the table appearing in the next page.

TABLE

| | |
|---|---|
| COUNT OF YARN | |
| COMPONENTS (Nm) | % YARN COMPONENTS |

| Silk | Other animal fibre | Silk | Other animal fibre |
|---|---|---|---|
| 1/600 | Cashmere 1/28 | 4.5% | 95.5% |
| 1/600 | Cashmere 1/45 | 7% | 93% |
| 1/600 | Wool 1/60 | 9.9% | 90.1% |
| 1/600 | Wool 1/66 | 10% | 90% |
| 1/600 | Wool 1/74 | 11.1% | 88.9% |
| 1/600 | Wool 1/96 | 13.8% | 86.2% |
| 1/600 | Wool 1/110 | 15.% | 84.5% |

The count of 1/600 for silk has been indicated in so far as it corresponds to a very fine thread, but it is understood that also threads having other counts can advantageously be used.

With percentages of threads of silk of 4.5% and of cashmere of 95.5% and a count of 1/28, the fabric that is obtained will not be particularly light or fine, but will in any case have characteristics that are acceptable for the purposes of the invention.

With percentages of threads of silk of 15% and of wool of 84.5% and a count of 1/110, certainly the fabric will be extremely light and extremely fine even though, with current techniques, we are at the limit of the possibility of working a yarn of wool with such a high count.

It may, however, be deemed that satisfactory results can be obtained even with percentages of threads of silk equal to but not lower than 2% and equal to but not higher than 20% with consequent percentages of the animal fibres that concur in the production of the fabric.

It may be readily understood that the combinations that can be obtained are multiple; everything depends upon the degree of fineness and lightness of the fabric that it is desired to obtain.

1. A fabric obtained by working yarn resulting from the twisting of natural fibres, wherein the natural fibres comprise animal fibres twisted with a strand of silk.

2. The fabric according to claim 1, wherein the percentage of threads of silk ranges from 2% to 20%, and the percentage of animal fibres ranges from 98% to the 80%.
